(19) United States
(12) Patent Application Publication
(10) Pub. No.: US 2014/0125020 A1
(43) Pub. Date: May 8, 2014

(54) Changing Pad Stroller Assembly

(71) Applicants: Raynold Sime, Jacksonville, FL (US); Andrea Sime, Jacksonville, FL (US)

(72) Inventors: Raynold Sime, Jacksonville, FL (US); Andrea Sime, Jacksonville, FL (US)

(21) Appl. No.: 13/671,627

(22) Filed: Nov. 8, 2012

(51) Int. Cl. B62B 7/04; B62B 3/02

(52) U.S. Cl. CPC B62B 7/04; B62B 3/02
USPC 280/47.4; 280/47.38

(57) ABSTRACT

A changing pad stroller assembly provides a selectively deployable diaper changing support on a stroller. The assembly includes a frame and a handle coupled to the frame. A plurality of wheels is coupled to the frame. A seat coupled to the frame and an upper tray is also coupled to the frame. The upper tray extends around a forward end of the seat. A main panel has a first edge pivotally coupled to a first side of the upper tray. The main panel is positionable to extend across the seat such that a second edge of the main panel engages second side of the upper tray.

### BACKGROUND OF THE DISCLOSURE

### Field of the Disclosure

The disclosure relates to stroller devices and more particularly pertains to a new stroller device for providing a selectively deployable diaper changing support on a stroller.

### SUMMARY OF THE DISCLOSURE

An embodiment of the disclosure meets the needs presented above by generally comprising a frame and a handle coupled to the frame. A plurality of wheels is coupled to the frame. A seat coupled to the frame and an upper tray is also coupled to the frame. The upper tray extends around a forward end of the seat. A main panel has a first edge pivotally coupled to a first side of the upper tray. The main panel is positionable to extend across the seat such that a second edge of the main panel engages second side of the upper tray.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side view of a changing pad stroller assembly according to an embodiment of the disclosure.

FIG. 2 is a top front side perspective view of an embodiment of the disclosure.

FIG. 3 is a top front side perspective view of an embodiment of the disclosure.

FIG. 4 is a top front side perspective view of an embodiment of the disclosure.

FIG. 5 is a cross-sectional view of an embodiment of the disclosure taken along line 5-5 of FIG. 4.

FIG. 6 is a top front side perspective view of a media player of an embodiment of the disclosure.

FIG. 7 is a top front side perspective view of an embodiment of the disclosure.

FIG. 8 is a top front side perspective view of an embodiment of the disclosure.

### DESCRIPTION OF THE PREFERRED EMBODIMENT

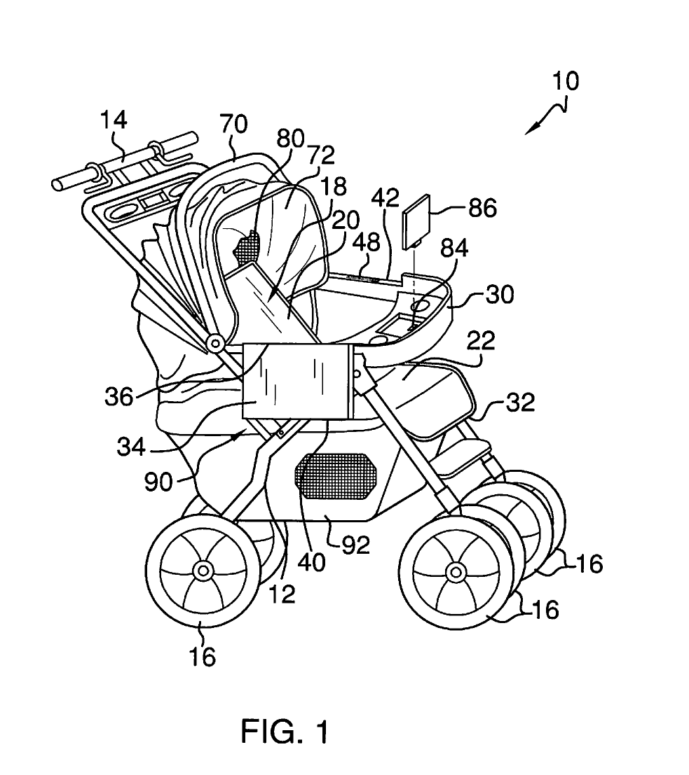

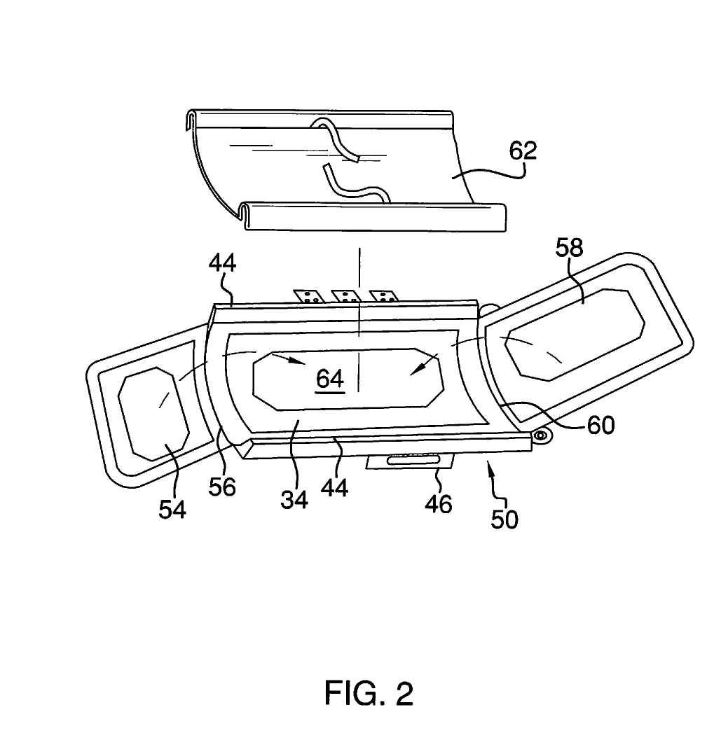

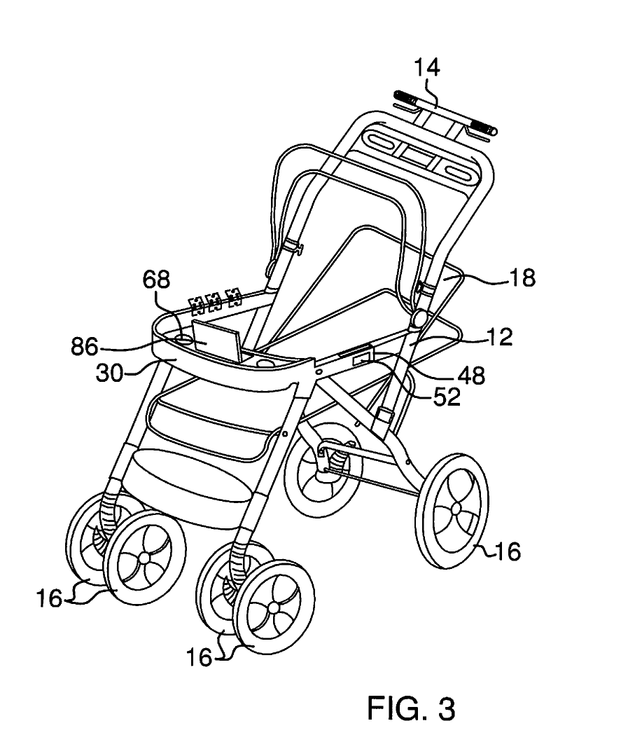

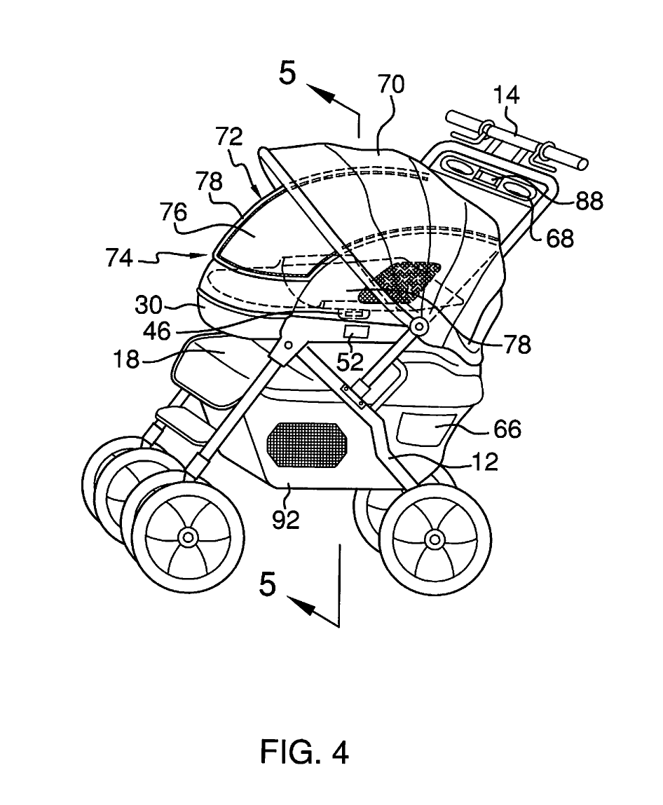

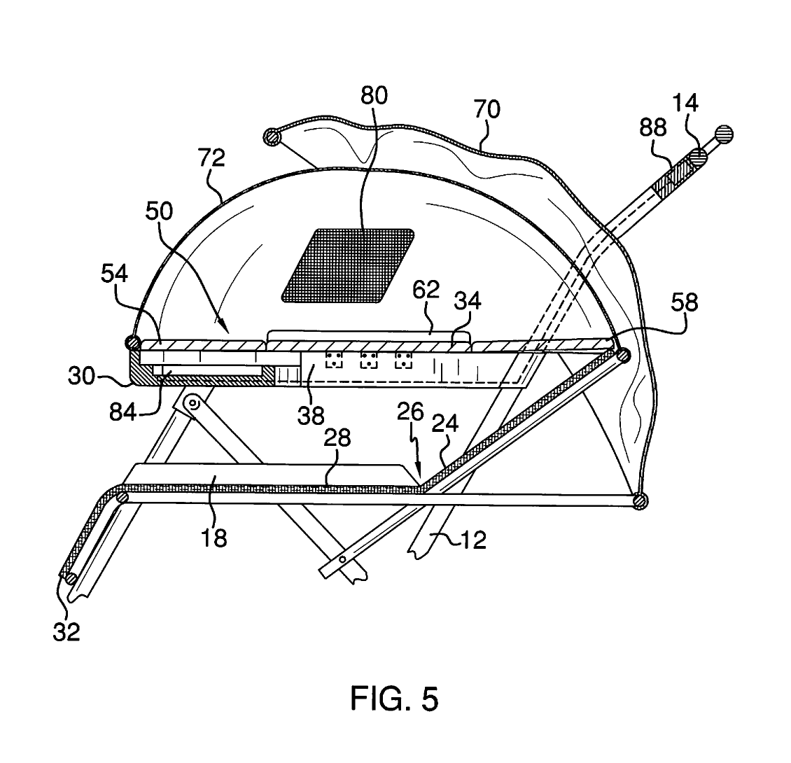

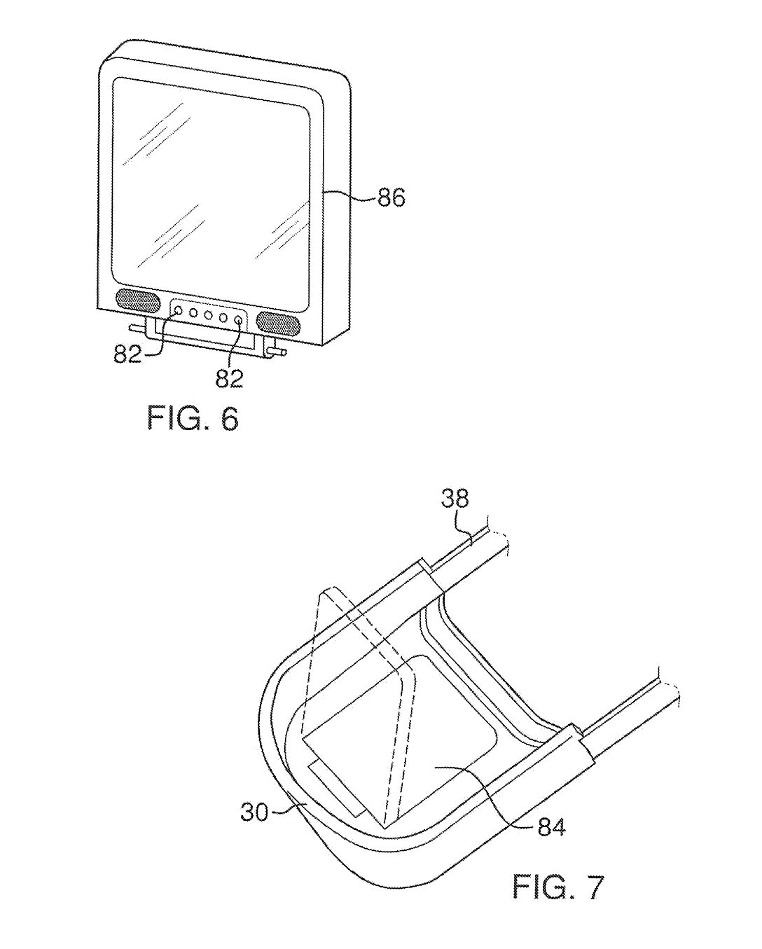

With reference now to the drawings, and in particular to FIGS. 1 through 8 thereof, a new stroller device embodying the principles and concepts of an embodiment of the disclosure and generally designated by the reference numeral 10 will be described.

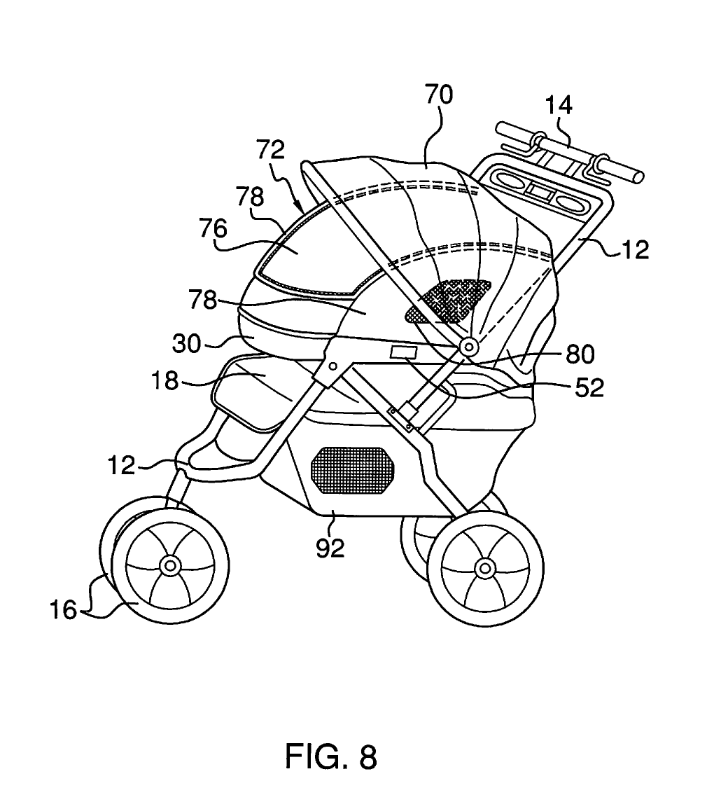

As best illustrated in FIGS. 1 through 8, the changing pad stroller assembly 10 generally comprises a frame 12 and a handle 14 coupled to the frame 12. A plurality of wheels 16 is coupled to the frame 12. The wheels 16 may be provided singly or in pairs positioned in four corners or in a triangular configuration, as shown in FIG. 8. A seat 18 is coupled to the frame 12. The seat 18 has a back portion 20 and a central portion 22. An upper surface 24 of the back portion 20 may form an obtuse angle 26 with an upper surface 28 of the central portion 22. The seat 18 may be designed such that an infant primarily lies in a prone position on the seat 18. An upper tray 30 is coupled to the frame 12. The upper tray 30 extends around a forward end 32 of the seat 18. A main panel 34 has a first edge 36 pivotally coupled to a first side 38 of the upper tray 30. The main panel 34 is positionable to extend across the seat 18 such that a second edge 40 of the main panel 34 engages second side 42 of the upper tray 30. The first side 38 and the second side 42 of the upper tray 30 may be coplanar and positioned in a horizontal plane. The main panel 34 may have raised sides 44 extending lengthwise along the main panel 34. Thus, the main panel 34 is configured for preventing an infant from rolling sideways off of the main panel 34.

A locking tab 46 is coupled to and extends from the second edge 40 of the main panel 34. A locking mechanism 48 is coupled to the second side 42 of the upper tray 30. The locking mechanism 48 engages the locking tab 46 in the same manner is a conventional seat belt buckle whereby the main panel 34 is secured in a deployed position 50 extending across the seat 18. A release button 52 is operationally coupled to the locking mechanism 48 for selectively uncoupling the locking tab 46 from the locking mechanism 48.

A foot panel 54 may be pivotally coupled to the main panel 34. The foot panel 54 is selectively positionable to extend from a bottom edge 56 of the main panel 34. A head panel 58 may also be pivotally coupled to the main panel 34. The head panel 58 is selectively positionable to extend from a top edge 60 of the main panel 34. A main pad 62 may be coupled to an upper face 64 of the main panel 34.

A main canopy 70 is coupled to the frame 12. The main canopy is selectively extendable over the seat 18, particularly the back portion 20 leaving the central portion 22 partially covered. A secondary canopy 72 is coupled to the frame 12. The secondary canopy 72 is extendable over the main panel 34 when the main panel 34 is in the deployed position 50. The secondary canopy 72 extends fully over the main panel 34, the foot panel 54 and the head panel 58 when the secondary canopy 72 is in a fully deployed position 74. The secondary canopy 72 may have a flap portion 76 positioned between two side portions 78. The flap portion 76 is releasably coupled to the side portions 78 whereby the flap portion 76 is retractable to provide access to the main panel 34 while the side portions 78 remain in the deployed position 74. A vent 80 is coupled to and extends through the secondary canopy 72.

A media socket 84 may be coupled to the upper tray 30. A media player 86 is selectively couplable to the media socket 84 and a plurality of media controls 88 is coupled to the handle 14. The media controls 88 are operationally coupled to the media socket 84 whereby the media player 86 is operable by manipulation of the media controls 88 on the handle 14 when the media player 86 is coupled to the media socket 84. The media player 86 may also be a stand alone player with controls 82 which pivotally couples to the media socket 84. Additional pockets 66, cup holders 68, a lower tray 92 positioned beneath the seat 18, and other conventional stroller accessories may be provided and incorporated into the assembly 10.

In use, an infant may be placed in the seat 18 and pushed using the handle 14. When the infant requires a diaper change, the main panel 34 may be pivoted into the deployed position 50 where it is secured by the locking tab 46 engaging the locking mechanism 48. The infant may be placed on the main pad 34 to change the infant's diaper. For privacy, the secondary canopy 72 may be deployed and the flap portion 76 drawn back to provide access to the infant on the main panel 34. When done, the infant may be lifted and the release button 52 manipulated to permit the main panel 34 to pivot back into a stored position 90 with the foot panel 54 and head panel 58 pivoted into a compact position between the frame 12 and the main panel 34. While the infant is in the seat 18, the media player 86 may be placed into the media socket 84. The media controls 88 may be manipulated to display desired media on the media player 86 such as lullabies to soothe the infant or a movie to entertain the infant while in the seat 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

We claim:

1. A stroller assembly comprising:
a frame;
a handle coupled to said frame;
a plurality of wheels coupled to said frame;
a seat coupled to said frame;
an upper tray coupled to said frame, said upper tray extending around a forward end of said seat; and
a main panel having a first edge pivotally coupled to a first side of said upper tray, said main panel being positionable to extend across said seat such that a second edge of said main panel engages second side of said upper tray.

2. The assembly of claim 1, further comprising:
a locking tab coupled to and extending from said second edge of said main panel; and
a locking mechanism coupled to said second side of said upper tray, said locking mechanism engaging said locking tab whereby said main panel is secured in a deployed position extending across said seat.

3. The assembly of claim 2, further including a release button operationally coupled to said locking mechanism for selectively uncoupling said locking tab from said locking mechanism.

4. The assembly of claim 1, further including a foot panel, said foot panel being coupled to said main panel, said foot panel being selectively positionable to extend from a bottom edge of said main panel.

5. The assembly of claim 1, further including a head panel, said head panel being coupled to said main panel, said head panel being selectively positionable to extend from a top edge of said main panel.

6. The assembly of claim 1, further including a main pad coupled to an upper face of said main panel.

7. The assembly of claim 1, further including said main panel having raised sides extending lengthwise along said main panel whereby said main panel is configured for preventing an infant from rolling sideways off of said main panel.

8. The assembly of claim 1, further including a main canopy coupled to said frame, said main canopy being selectively extendable over said seat.

9. The assembly of claim 1, further including a secondary canopy coupled to said frame, said secondary canopy being extendable over said main panel when said main panel is in said deployed position.

10. The assembly of claim 9, further including a vent coupled to and extending through said secondary canopy.

11. The assembly of claim 9, further comprising:
a foot panel, said foot panel being coupled to said main panel, said foot panel being selectively positionable to extend from a bottom edge of said main panel;
a head panel, said head panel being coupled to said main panel, said head panel being selectively positionable to extend from a top edge of said main panel; and
said secondary canopy extending fully over said main panel, said foot panel, and said head panel when said secondary canopy is in a fully deployed position.

12. The assembly of claim 1, further comprising:
a media socket coupled to said upper tray; and
a media player selectively couplable to said media socket.

13. The assembly of claim 12, further including media controls coupled to said handle, said media controls being operationally coupled to said media socket whereby said media player is operable by manipulation of said media controls on said handle when said media player is coupled to said media socket.

14. The assembly of claim 1, further including said seat having a back portion and a central portion, an upper surface of said back portion forming an obtuse angle with an upper surface of said central portion.

15. The assembly of claim 11, further including said secondary canopy having a flap portion positioned between two side portions, said flap portion being releasably coupled to said side portions whereby said flap portion is retractable to provide access to said main panel while said side portions remain in said deployed position.

16. A stroller assembly comprising:
a frame;
a handle coupled to said frame;
a plurality of wheels coupled to said frame;
a seat coupled to said frame, said seat having a back portion and a central portion, an upper surface of said back portion forming an obtuse angle with an upper surface of said central portion;
an upper tray coupled to said frame, said upper tray extending around a forward end of said seat;
a main panel having a first edge pivotally coupled to a first side of said upper tray, said main panel being positionable to extend across said seat such that a second edge of said main panel engages second side of said upper tray, said main panel having raised sides extending lengthwise along said main panel whereby said main panel is configured for preventing an infant from rolling sideways off of said main panel;
a locking tab coupled to and extending from said second edge of said main panel;
a locking mechanism coupled to said second side of said upper tray, said locking mechanism engaging said locking tab whereby said main panel is secured in a deployed position extending across said seat;
a release button operationally coupled to said locking mechanism for selectively uncoupling said locking tab from said locking mechanism;
a foot panel, said foot panel being coupled to said main panel, said foot panel being selectively positionable to extend from a bottom edge of said main panel;
a head panel, said head panel being coupled to said main panel, said head panel being selectively positionable to extend from a top edge of said main panel;
a main pad coupled to an upper face of said main panel;
a main canopy coupled to said frame, said main canopy being selectively extendable over said seat;
a secondary canopy coupled to said frame, said secondary canopy being extendable over said main panel when said main panel is in said deployed position, said secondary canopy extending fully over said main panel, said foot panel, and said head panel when said secondary canopy is in a fully deployed position, said secondary canopy having a flap portion positioned between two side portions, said flap portion being releasably coupled to said side portions whereby said flap portion is retractable to provide access to said main panel while said side portions remain in said deployed position;
a vent coupled to and extending through said secondary canopy; and
a media socket coupled to said upper tray;
a media player selectively couplable to said media socket; and
a plurality of media controls coupled to said handle, said media controls being operationally coupled to said media socket whereby said media player is operable by manipulation of said media controls on said handle when said media player is coupled to said media socket.
